(19) United States
(12) Patent Application Publication
(10) Pub. No.: US 2026/0210885 A1
(43) Pub. Date: Jul. 23, 2026

(54) RF-BASED AI DETERMINATION OF MATERIALS BY CYCLING THROUGH DETECTION PATTERNS FOR SPECIFIC APPLICATIONS

(71) Applicant: QUANTUM IP, LLC, Stuart, FL (US)

(72) Inventors: Robert J, Short, JR., Stuart, FL (US); Lee Duke, Stuart, FL (US); John Cronin, Stuart, FL (US); Michael D'Andrea, Stuart, FL (US); Joseph Bodkin, Stuart, FL (US)

(21) Appl. No.: 18/938,691

(22) Filed: Nov. 6, 2024

Related U.S. Application Data
(60) Provisional application No. 63/668,645, filed on Jul. 8, 2024.

(51) Int. Cl. G01N 24/08

(52) U.S. Cl. CPC G01N 24/084

(57) ABSTRACT

A system includes an communication interface for accessing a material database associating each of a plurality of materials with one or more corresponding resonance frequencies, the plurality of materials including a target material; an RF transmitter configured to transmit into an environment an RF signal at the resonance frequency for the target material extracted from the material database; an RF receiver configured to receive a response signal from the environment; and a processor configured to: analyze the response signal for resonance characteristics that indicate a presence of the target material in the environment; and if the presence of the target material is indicated, use a large language model (LLM) to determine a set of one or more related materials to the target material.

### CROSS-REFERENCE TO RELATED APPLICATIONS

This application claims the benefit of U.S. Provisional Application No. 63/668,645, filed Jul. 8, 2024, which is incorporated herein by reference.

### FIELD OF THE DISCLOSURE

The present disclosure is generally related to an RF-based material detection and, more specifically, to AI determination of materials by cycling through detection patterns for specific applications.

### BACKGROUND

Currently, traditional detection systems struggle to accurately identify materials or substances in environments with high levels of interference and noise. Many current detection techniques require invasive procedures, causing discomfort and risk to the subjects being examined. Also, conventional methods often fail to efficiently identify targeted substances due to their reliance on single-frequency detection. Existing detection systems lack the sensitivity needed to identify materials at very low concentrations or in challenging conditions. High rates of false positives and negatives in current detection systems lead to unreliable results and inefficient processes. Lastly, static detection systems cannot adapt to varying conditions and require frequent recalibration. Many detection systems are resource-intensive, requiring significant power and complex support materials. Current detection solutions are often tailored to specific applications and are not easily scalable or versatile. Thus, there is a need in the prior art for an AI determination of cycling through detection patterns for specific applications.

### SUMMARY

According to one aspect, a method includes receiving a selection of a target material from a user. The method also includes accessing a material database associating each of a plurality of materials with one or more corresponding resonance frequencies, the plurality of materials including the target material. The method further includes extracting a resonance frequency for the target material from the material database. In addition, the method includes transmitting into an environment an RF signal at the resonance frequency for the target material. The method also includes receiving a response signal from the environment and analyzing the response signal for resonance characteristics that indicate a presence of the target material in the environment. The method further includes, if the presence of the target material is indicated, using a large language model (LLM) to determine a set of one or more related materials to the target material and, for each related material of the set of one or more related materials, extracting the resonance frequency for the related material from the material database; transmitting into the environment an additional RF signal at the resonance frequency for the related material; receiving an additional response signal from the environment; and analyzing the response signal for resonance characteristics that indicate a presence of the related material in the environment. The method additionally includes storing an indication of the target material and each related material indicated to be within the environment.

In some embodiments, the method further includes using a probability algorithm to determine a probability of the target material being in the environment based, at least in part, on the presence of each related material indicated to be in the environment.

In some embodiments, using the probability algorithm includes assigning a base probability value to detection of the target material and adjusting the base probability value responsive to detection of the one or more related materials.

In some embodiments, adjusting the base probability value includes aggregating influences from all detected related materials and normalizing a final probability score to within a predetermined range.

In some embodiments, the probability algorithm includes a Rainforest probability function.

In some embodiments, the method further includes outputting to a user interface at least one of an indication of the target material, an indication of the probability of the target material being in the environment, or an indication of each related material indicated to be in the environment.

In some embodiments, the LLM is a pre-trained Bidirectional Encoder Representations from Transformers (BERT) model.

In some embodiments, the resonance frequency of the target material is related to an atomic structure of the target material.

In some embodiments, the material database associates each of the plurality of materials with one or more corresponding power levels, and the RF signal is transmitted into the environment at a power level associated with the target material in the material database.

In some embodiments, storing the indication of the target material and each related material indicated to be within the environment includes storing an indication of the target material and each related material indicated to be within the environment in a probability database along with one or more associated frequencies and/or power levels associated with the target material and/or related materials.

According to another aspect, a system includes a user interface configured to receive a selection of a target material from a user. The system also includes a communication interface for accessing a material database associating each of a plurality of materials with one or more corresponding resonance frequencies, the plurality of materials including the target material. The system further includes an RF transmitter configured to transmit into an environment an RF signal at the resonance frequency for the target material extracted from the material database. In addition, the system includes an RF receiver configured to receive a response signal from the environment. The method also includes a processor configured to analyze the response signal for resonance characteristics that indicate a presence of the target material in the environment and, if the presence of the target material is indicated, use a large language model (LLM) to determine a set of one or more related materials to the target material; for each related material of the set of one or more related materials: transmit into the environment an additional RF signal at the resonance frequency for the related material extracted from the material database; receive an additional response signal from the environment; and analyze the response signal for resonance characteristics that indicate a presence of the related material in the environment; and store an indication of the target material and each related material indicated to be within the environment.

In some embodiments, the processor is further configured to use a probability algorithm to determine a probability of the target material being in the environment based, at least in part, on the presence of each related material indicated to be in the environment.

In some embodiments, the processor is further configured to use the probability algorithm by assigning a base probability value to detection of the target material and adjusting the base probability value responsive to detection of the one or more related materials.

In some embodiments, the processor is further configured to adjust the base probability value by aggregating influences from all detected related materials and normalizing a final probability score to within a predetermined range.

In some embodiments, the probability algorithm includes a Rainforest probability function.

In some embodiments, the user interface is further configured to output at least one of an indication of the target material, an indication of the probability of the target material being in the environment, or an indication of each related material indicated to be in the environment.

In some embodiments, the LLM is a pre-trained Bidirectional Encoder Representations from Transformers (BERT) model.

In some embodiments, the resonance frequency of the target material is related to an atomic structure of the target material.

In some embodiments, the material database associates each of the plurality of materials with one or more corresponding power levels, and the RF transmitter is configured to transmit the RF signal into the environment at a power level associated with the target material in the material database.

In some embodiments, the processor is further configured to store the indication of the target material and each related material indicated to be within the environment by storing an indication of the target material and each related material indicated to be within the environment in a probability database along with one or more associated frequencies and/or power levels associated with the target material and/or related materials.

### BRIEF DESCRIPTION OF THE DRAWINGS

FIG. 1 is a schematic diagram of an RF Detection System, according to an embodiment.

FIG. 2 is a flow chart of a method performed by a Base Module, according to an embodiment.

FIG. 3 is a flow chart of a method performed by a Detection Module, according to an embodiment.

FIG. 4 is a flow chart of a method performed by a large language model (LLM) Module, according to an embodiment.

FIG. 5 is a flow chart of a method performed by an Enhance Module, according to an embodiment.

FIG. 6 is a flow chart of a method performed by a Probability Module, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

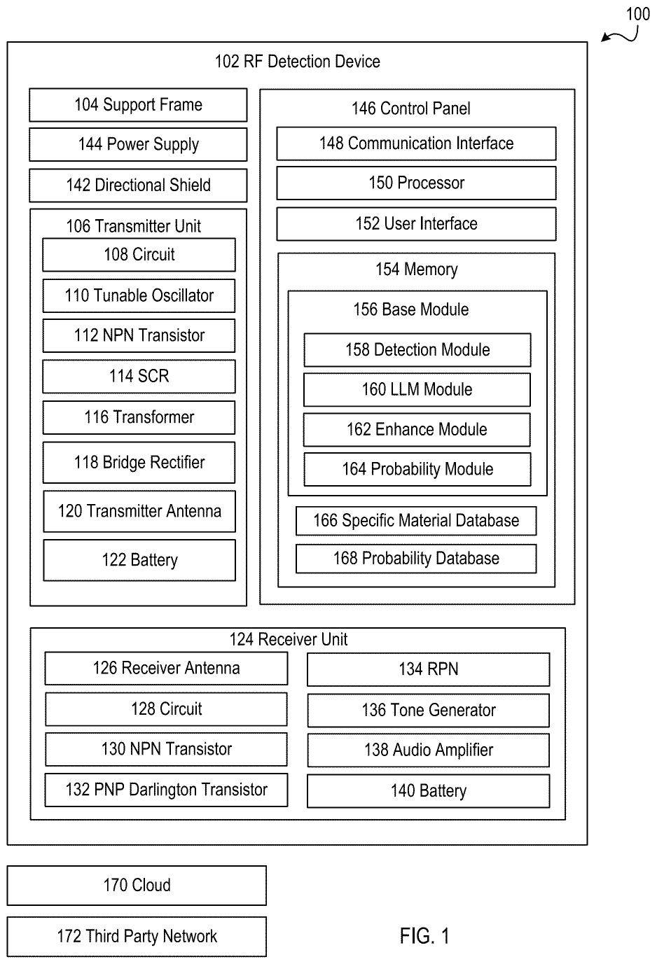

FIG. 1 illustrates an RF detection system 100. The system 100 comprises an RF detection device 102, which may be a specialized system designed to detect and identify specific materials based on their unique resonance frequencies when exposed to electromagnetic signals. The RF detection device 102 incorporates an RF detection system similar to that disclosed in patent U.S. Pat. No. 11,493,494B2, employing RF signals for the detection and identification of materials based on their resonance characteristics. The RF detection device 102 may operate by transmitting RF signals into the environment and analyzing the received signals for resonance characteristics that indicate the presence of a target material. The RF detection device 102 may be designed to detect a target material based on its resonance properties with specific RF frequencies. It utilizes the principle that materials resonate at particular frequencies when exposed to external RF signals, allowing for their identification and potential quantification. The RF detection device 102 may include a transmitter unit 106, a receiver unit 124, a control panel 146, a transmitter antenna 120, a receiver antenna 126, a directional shield 142, and a power supply 144. Upon activation, the control panel 146 initializes the system, powering up the transmitter unit 106, the receiver unit 124, and associated electronics. The control panel 146 may instruct the transmitter unit 106 to generate RF signals at specified frequencies, such as 180 Hz, 1800 Hz, etc., and amplitudes, such as 320V, 160V, etc., known to resonate with a target material. The transmitter unit 106 emits these RF signals through the transmitter antenna 120 into the testing environment. The receiver unit 124 captures the RF signals using the receiver antenna 126. It then processes the received signals to identify resonance frequencies that indicate the presence of the target material.

Further, embodiments may include a support frame 104, which may be a structural component designed to provide stability and support to various subsystems and components of the RF detection device 102. The support frame 104 may provide proper alignment and positioning of the components, such as the transmitter unit 106, receiver unit 124, and control panel 146. The support frame 104 may provide mounting points and secure attachment locations for subsystems such as the transmitter unit 106, receiver unit 124, and control panel 146. By maintaining precise alignment and stability, the support frame 104 may minimize vibrations and unwanted movements that could interfere with the accuracy of RF signal transmission and reception. In some embodiments, the support frame 104 may be constructed from durable materials such as metal alloys or rigid polymers.

Further, embodiments may include a transmitter unit 106, which may include an electronic circuit 108, powered by a battery 122, such as a 12-volt, 1.2 amp battery, with a regulated output of nine volts. The circuit 108 may use a 555 timer as a tunable oscillator 110 to generate a pulse rate. The output of the oscillator 110 is fed in parallel to an NPN transistor 112 and a silicon-controlled rectifier or SCR 114. The transistor may be used as a common emitter amplifier stage driving a transformer 116. The transformer 116 may be used to step up the voltage as needed. The balanced output of the transformer 116 feeds a bridge rectifier 118. The rectified direct current flows through a 100 K, three-watt resistor to terminal B of the transmitter antenna 120. A plurality of resistors and capacitors may fill in the circuit 108. In some embodiments, the transmitter antenna 120 may be formed from a coil of about 25 meters of 14-strand wire tightly wound around a one-centimeter PVC core. The transmitter antenna 120 may be, in one exemplary embodiment, in a 1″×3″ configuration at the bottom end of the support frame 104. In some embodiments, the transmitter antenna 120 may be shielded approximately 315 degrees with the directional shield 142, formed from aluminum and copper, leaving a two-inch opening. Terminal A of the transmitter antenna 120 is switched to ground through the SCR 114. The SCR 114 is “fired” by the output of the 555 timer. This particular configuration generates a narrow pulsed waveform to the transmitter antenna 120 at a pulse rate as set by the 555 timer. Power is delivered through the 3 W resistor. Frequencies down to 4 Hz are achieved by an RC network containing a 100 K pot, a switch, and one of two capacitive paths. The circuit 108 may provide simple RC-controlled timing and deliver pulses to the primary of a step-up transformer 116, the output of which is full-wave rectified and fed to the transmitter antenna 120. The pulse rate is adjustable from the low Hz range to the low kHz range. The sharp pulses at low repetition frequencies yield a wide spectrum of closely spaced lines. The pulse rate is adjusted depending on the material to be detected. In some embodiments, one or more portions of the transmitter unit 106 may be implemented in an analog circuit configuration, a digital circuit configuration, or some combination thereof. In one example, the analog configuration may include one or more analog circuit components, such as, but not limited to, operational amplifiers, op-amps, resistors, inductors, and capacitors. In another example, the digital configuration may include one or more digital circuit components, such as, but not limited to, microprocessors, logic gates, and transistor-based switches. In some instances, a given logic gate may include one or more electronically controlled switches, such as transistors, and the output of a first logic gate may control one or more logic gates disposed “downstream” from the first logic gate.

Further, embodiments may include a circuit 108, which may be an assembly of electronic components that generate, modulate, and transmit radio frequency, RF, signals. The circuit 108 may include oscillators 110, amplifiers, modulators, and other components that work together to produce a specific RF signal, which can then be transmitted through the transmitter antenna 120. The circuit 108 may include an oscillator 110, which generates a stable RF signal at a specified frequency. This frequency is selected based on the resonance characteristics of the target material. For example, the system may operate at 180 Hz or 1800 Hz, depending on the specific requirements of the detection task. Once generated, the RF signal is fed into an amplifier. The amplifier boosts the signal strength to a level suitable for transmission over the required distance. This ensures that the signal can propagate through various media and reach the receiver unit 124 effectively. Modulation circuits are used to encode information into the RF signal. This may involve varying the amplitude, frequency, or phase of the signal to carry specific data related to the detection process. Modulation ensures that the transmitted signal can be uniquely identified and distinguished from other signals in the environment. The circuit 108 may include power control components that regulate the voltage and current supplied to the oscillator 110 and amplifier. This ensures consistent signal output and helps in managing the power consumption of the device. In some embodiments, the transmitter unit 106 may operate at voltages such as 160V and 320V, with adjustments made to optimize detection performance. The amplified and modulated RF signal is then routed to the transmitter antenna 120. The transmitter antenna 120 converts the electrical signal into an electromagnetic wave that can propagate through the air or other media. In some embodiments, the circuit 108 may be integrated with the device's control systems, allowing for automated adjustments based on pre-set parameters or operator inputs.

Further, embodiments may include a tunable oscillator 110, which may be a type of electronic component that generates a periodic waveform with a frequency that can be adjusted or tuned over a specific range. The tunable oscillator 110 within the transmitter unit 106 may be utilized to generate the RF signal that will be transmitted by the RF detection system 102. The tunable oscillator 110 in the transmitter unit 106 may be employed to produce an RF signal whose frequency can be precisely controlled. By adjusting the control inputs, the frequency of the output signal can be varied, allowing the system to adapt to different detection requirements and environmental conditions. This tuning mechanism may ensure that the oscillator 110 produces a signal at the correct frequency needed for effective resonance with the target materials. By tuning the oscillator 110 to specific frequencies, the system may detect various substances based on their unique resonant properties. The tunable oscillator 110 may work in conjunction with the control panel 146, which sends control signals to adjust the oscillator's 110 frequency as needed. The tunable oscillator 110 may act as the core signal generation component in the transmitter unit 106. When the control panel 146 determines the required frequency for detection, it sends control signals to the tunable oscillator 110. The oscillator 110 then adjusts its frequency accordingly, generating an RF signal that matches the desired parameters. The tunable oscillator 110 may be connected to other components within the transmitter unit 106, such as the SCR 114 and the transformer 116. The SCR 114 manages the power supply to the oscillator 110, ensuring it receives the correct voltage. The transformer 116 steps up the voltage to the appropriate level required by the oscillator 110.

Further, embodiments may include an NPN transistor 112, which may be a type of bipolar junction transistor, BJT, that consists of three layers of semiconductor material: a layer of p-type material, the base layer, sandwiched between two layers of n-type material, the emitter and the collector. When a small current flows into the base, it allows a larger current to flow from the collector to the emitter, effectively acting as a current amplifier or switch in electronic circuits. The NPN transistor 112 in the transmitter unit 106 amplifies the RF signal generated by the oscillator 110. The NPN transistor 112 may operate in its active region, where a small input current applied to the base controls a larger current flowing from the collector to the emitter. This amplification process ensures that the RF signal reaches a sufficient power level for effective transmission. In some embodiments, the NPN transistor 112 may also function as a switch, controlling the flow of current within the circuit 108. When the base-emitter junction is forward-biased, a small voltage is applied, and the NPN transistor 112 allows current to flow from the collector to the emitter. This switching action is used to modulate the RF signal, encoding information onto the carrier wave as required for the detection process. Proper biasing of the NPN transistor 112 is helpful for stable operation. In some embodiments, resistors may be used to establish the correct biasing conditions to ensure that the NPN transistor 112 operates in its linear region for amplification or in saturation/cutoff regions for switching. The biasing circuit ensures that the NPN transistor 112 responds predictably to input signals, maintaining signal integrity. In some embodiments, the NPN transistor 112 may be involved in modulating the RF signal. By varying the input current to the base, the amplitude, frequency, or phase of the RF signal can be modulated. This modulation is critical for encoding the detection data onto the transmitted signal, allowing for accurate identification and analysis. In some embodiments, the NPN transistor 112 may be integrated into the broader transmitter circuit 108, working in conjunction with other components such as capacitors, inductors, and resistors. This integration ensures that the NPN transistor's 112 amplification and switching actions are synchronized with the overall signal generation and transmission process. The circuit 108 design may leverage the NPN transistor's 112 properties to achieve the desired RF output characteristics.

Further, embodiments may include an SCR 114, or silicon-controlled rectifier, which may be a type of semiconductor device that functions as a switch and rectifier, allowing current to flow only when a control voltage is applied to its gate terminal. The SCR 114 is utilized within the transmitter unit 106 to manage and control the power delivery to the RF signal generation components. The SCR 114 in the transmitter unit 106 may be employed to control the flow of power to the RF oscillator 110 circuit 108. By applying a gate signal to the SCR 114, it switches from a non-conductive state to a conductive state, allowing current to pass through and power the oscillator 110. This control mechanism ensures that the oscillator 110 only receives power when required, thereby conserving energy and preventing unnecessary power dissipation. The SCR 114 may act as a switching element in the transmitter unit 106. When the control panel 146 determines that the RF signal needs to be generated, a gate voltage is applied to the SCR 114. This triggers the SCR 114 to conduct, completing the circuit and enabling current to flow to the RF oscillator 110. The SCR 114 may ensure that sufficient current is supplied to the oscillator 110 to produce a strong RF signal without being damaged by the high power levels. The gate terminal of the SCR 114 may be connected to the control panel 146, which manages the timing and application of the gate signal. This integration ensures that the SCR 114 is activated precisely when the RF signal needs to be transmitted, in sync with the overall operation of the RF detection device 102. The control panel 146 sends the appropriate signal to the SCR 114, ensuring accurate timing and efficient power usage. The SCR 114 may also serve as a protective component in the transmitter unit 106. By controlling the power flow, it prevents overloading and potential damage to the RF oscillator 110 and other sensitive components. If the system detects any abnormal conditions, the control panel 146 can withhold the gate signal, keeping the SCR 114 in a non-conductive state and thereby cutting off power to protect the circuit 108.

Further, embodiments may include a transformer 116, which is an electrical device that transfers electrical energy between two or more circuits through electromagnetic induction. The transformer 116 is utilized within the transmitter unit 106 to manage and control the voltage levels required for the RF signal generation and transmission. The transformer 116 in the transmitter unit 106 may be employed to step up or step down the voltage as needed to ensure the proper operation of the RF oscillator 110 circuit 108. By adjusting the voltage levels, the transformer 116 ensures that the components within the transmitter unit 106 receive the appropriate voltage for efficient functioning. The transformer 116 may act as a voltage regulation element in the transmitter unit 106. When the control panel 146 determines that the RF signal needs to be generated, the transformer 116 adjusts the input voltage to the desired level. This adjustment involves converting the primary winding voltage to a higher or lower voltage in the secondary winding, depending on the requirements of the RF oscillator 110. The transformer 116 ensures that the oscillator 110 receives a stable and appropriate voltage, which is critical for producing a consistent and strong RF signal. The primary winding of the transformer 116 may be connected to the battery 122, while the secondary winding is connected to the RF oscillator circuit 110. This integration ensures that the transformer 116 can effectively manage the voltage levels needed for RF signal generation. The control panel 146 monitors and regulates the input voltage to the transformer 116, ensuring accurate and efficient voltage conversion and delivery to the RF oscillator 110.

Further, embodiments may include a bridge rectifier 118, which is an electrical device designed to convert alternating current, AC, to direct current, DC, using a combination of four diodes arranged in a bridge configuration. The bridge rectifier 118 is utilized within the transmitter unit 106 to ensure that the RF signal generation components receive a steady and reliable DC power supply. The bridge rectifier 118 in the transmitter unit 106 may be employed to convert the incoming AC voltage from the battery 122 into a DC voltage. By using all portions of the AC waveform, the bridge rectifier 118 provides full-wave rectification, resulting in a more efficient conversion process and producing a smoother and more stable DC output. The bridge rectifier 118 may act as a power conversion element in the transmitter unit 106. When the control panel 146 determines that the RF signal needs to be generated, the AC voltage supplied to the transmitter unit 106 is passed through the bridge rectifier 118. The bridge rectifier 118 converts the AC voltage into a DC voltage by directing the positive and negative halves of the AC waveform through the appropriate diodes. This process results in a continuous DC voltage output that is used to power the RF oscillator 110 and other critical components. The input terminals of the bridge rectifier 118 may be connected to an AC power supply, while the output terminals provide the rectified DC voltage to the RF oscillator 110 circuit 108. This integration ensures that the bridge rectifier 118 can effectively convert and deliver the required DC power for RF signal generation. The control panel 146 monitors the output of the bridge rectifier 118, ensuring that the DC voltage is stable and within the desired range for optimal performance.

Further, embodiments may include a transmitter antenna 120, which may be a device that radiates radio frequency, RF, signals generated by the transmitter unit 106 towards a target material. The transmitter antenna 120 may be designed to efficiently transmit the generated RF signals into the surrounding environment and ensure the signals reach the intended target with minimal loss. The transmitter antenna 120 may be responsible for the emission of RF signals necessary for detecting materials at a distance. In some embodiments, the transmitter antenna 120 may operate within a specific frequency range suitable for detecting the atomic structures and characteristics of the target materials. The frequency range may be determined by the system's requirements and the properties of the materials being detected. In some embodiments, the gain of the transmitter antenna 120 may be a measure of its ability to direct the RF energy toward the target. Higher gain antennas focus the energy more effectively, resulting in stronger signal transmission over longer distances. The transmitter antenna 120 gain may be optimized for the operational frequency range. In some embodiments, the radiation pattern of the transmitter antenna 120 describes the distribution of radiated energy in space. For effective material detection, the transmitter antenna 120 may have a directional radiation pattern, concentrating the RF energy in a specific direction to enhance detection accuracy. In some embodiments, impedance matching between the transmitter antenna 120 and the transmitter unit 106 may maximize power transfer and minimize signal response. Proper impedance matching may ensure efficient operation and reduce losses in the transmission path. In some embodiments, the physical design of the transmitter antenna 120 may include configurations such as dipole, patch, or horn antennas, depending on factors such as frequency range, gain, and environmental conditions. In some embodiments, the transmitter antenna 120 may be integrated with the transmitter unit 106 and other system components through connectors and mounting structures to ensure stable and reliable operation, with considerations for minimizing interference and signal loss.

Further, embodiments may include a battery 122, which may be a type of energy storage device that provides a stable and portable power source for the transmitter unit 106. The battery 122 within the transmitter unit 106 may be utilized to supply electrical energy to the various components involved in generating and transmitting the RF signal. The battery 122 may be designed to store electrical energy and supply it to the respective components as required. The battery 122 may be rechargeable or replaceable cells capable of providing DC voltage. They are selected based on factors such as voltage output, and capacity, which may be measured in ampere-hours, Ah, and size to meet the power requirements of each component effectively. In the transmitter unit 106, battery 122 may serve as a portable power source, enabling the generation and transmission of RF signals without requiring a direct connection to an external power supply. The battery 122 may power components such as the oscillator 110 circuit 108, SCR 114, and transformer 116, ensuring continuous operation in various environmental conditions. In some embodiments, the battery 122 used may include lithium-ion, nickel-metal hydride, or other types suitable for portable electronic devices.

Further, embodiments may include a receiver unit 124, which may include the electronic circuit 128. Voltage from the receiver antenna 126 passes through a 10 K gain pot to an NPN transistor 130 used as a common emitter. The output is capacitively coupled to a PNP Darlington transistor 132. A plurality of resistors and capacitors fills in the circuit 128. The output is fed through a RPN 134 to a 555 timer that is used as a voltage-controlled oscillator. A received signal of a given amplitude generates an audible tone at a given frequency. In some embodiments, the output is fed to a tone generator 136, such as a speaker, via a standard 386 audio amp. Sounds can be categorized as “grunts,” “whines,” and a particular form of whine with a higher harmonic notably present. In some embodiments, another indicator of a received signal is used, such as light, vibration, digital display, or analog display, in alternative to or in combination with the sound signal. A battery 140 may be used to power the receiver circuit 128. The receiver circuit 128 may utilize a coherent, direct-conversion mixer, homodyne, with RF gain, yielding a baseband signal centered about DC. After a baseband gain stage, the baseband signal is fed to another timing circuit that functions as a voltage-controlled audio-frequency oscillator. The output of this oscillator is amplified and fed to a speaker. In some embodiments, one or more portions of the receiver unit 124 may be implemented in an analog circuit configuration, a digital circuit configuration, or some combination thereof. In one example, the analog configuration may include one or more analog circuit components, such as, but not limited to, operational amplifiers 138, op-amps, resistors, inductors, and capacitors. In another example, the digital configuration may include one or more digital circuit components, such as, but not limited to, microprocessors, logic gates, and transistor-based switches. In some instances, a given logic gate may include one or more electronically controlled switches, such as transistors, and the output of a first logic gate may control one or more logic gates disposed “downstream” from the first logic gate.

Further, embodiments may include a receiver antenna 126, which may be a device that captures the radio frequency, RF, signals responded from a target material. The receiver antenna 126 may be designed to efficiently receive the responded RF signals and transmit them to the receiver unit 124 for further processing and analysis. The receiver antenna 126 may be responsible for capturing the RF signals that have interacted with the target material. In some embodiments, the receiver antenna 126 may be designed to operate within the same frequency range as the transmitter antenna 120 to ensure compatibility and optimal performance for detecting the atomic structures and characteristics of the target materials. In some embodiments, the sensitivity may be a measurement of the receiver antenna's 126 ability to detect weak signals. A highly sensitive receiver antenna 126 may detect low-power responded signals, enhancing the system's detection capabilities. In some embodiments, the noise figure of the receiver antenna 126 may indicate the level of noise it introduces into the received signal. A lower noise figure may be desirable as it ensures that the captured signals are as clean and strong as possible for accurate processing. In some embodiments, proper impedance matching between the receiver antenna 126 and the receiver unit 124 may minimize signal response and maximize the power transfer from the receiver antenna 126 to the processing unit to ensure efficient and accurate signal reception. In some embodiments, the directional properties of the receiver antenna 126 may determine its ability to capture signals from specific directions to distinguish signals responded from the target material versus other sources of interference. In some embodiments, the gain of the receiver antenna 126 may enhance its ability to receive signals from distant targets. Higher gain receiver antennas 126 can improve the system's ability to detect materials at greater distances. In some embodiments, the physical design of the receiver antenna 126 may include various configurations such as dipole, patch, or parabolic antennas and may be based on factors such as frequency range, gain, and the specific detection requirements. In some embodiments, the receiver antenna 126 may be integrated with the receiver unit 124 and other system components through connectors and mounting structures to ensure stable and reliable operation, with considerations for minimizing interference and signal loss. In some embodiments, the receiver antenna 126 and the transmitter antenna 120 may be a single antenna used by the RF detection device 102.

Further, embodiments may include a circuit 128 within the receiver unit 124, which may be an assembly of electrical components designed to process the received RF signal. The circuit 128 may accurately interpret the RF signals responded or emitted from the target substances and convert them into data that can be analyzed by the RF detection device 102. The circuit 128 in the receiver unit 124 may be employed to handle signal amplification, filtering, demodulation, and signal processing. When an RF signal is received via the receiver antenna 126, it is typically weak and may contain noise or interference. The first stage of the circuit 128 may involve an amplifier that boosts the signal strength to a level suitable for further processing. This amplification ensures that even weak signals can be analyzed effectively. Next, the circuit 128 may include filtering components that serve to remove unwanted frequencies and noise from the received signal. Filters ensure that only the relevant frequency components of the RF signal are passed through, enhancing the signal-to-noise ratio and improving the clarity of the data. The circuit 128 may also incorporate a demodulator, which extracts the original information-bearing signal from the modulated RF carrier wave. This step interprets the data encoded in the RF signal, allowing the system to identify specific characteristics or signatures of the target substances. In some embodiments, the circuit 128 may include various signal processing components, such as analog-to-digital converters, ADCs, which convert the analog RF signal into digital data. This digital data may then be processed by the control panel 146 or other computational units within the system for detailed analysis. The signal processing may involve algorithms to detect specific patterns, frequencies, or anomalies that indicate the presence of target materials. The components within the circuit 128 interact seamlessly to ensure accurate and efficient signal processing. For example, the amplified signal from the amplifier is passed to the filter, which cleans up the signal before it reaches the demodulator. The demodulated signal is then digitized by the ADC and sent to the control panel 146 for analysis.

Further, embodiments may include an NPN transistor 130, which may be a three-terminal semiconductor device used for amplification and switching of electrical signals. The NPN transistor 130 may consist of three layers of semiconductor material: a thin middle layer, or base, between two heavily doped layers, or emitter and collector. The NPN transistor 130 operates by controlling the flow of current from the collector to the emitter, regulated by the voltage applied to the base terminal. The NPN transistor 130 integrated into the receiver unit 124 may be designed to process incoming RF signals and may operate in a configuration where the base-emitter junction is forward-biased by a small control voltage, provided by preceding stages of the circuit 128. The collector of the NPN transistor 130 may be connected to the circuit's 128 supply voltage through a load resistor. When a small current flows into the base terminal, it allows a larger current to flow from the collector to the emitter. This amplification process increases the strength of the received signal, enabling subsequent stages of the circuit 128 to process it more effectively. In the receiver unit 124, the NPN transistor 130 may be employed within amplifier stages where signal gain is beneficial. By controlling the base current, the circuit 128 can modulate the NPN transistor's 130 conductivity and thereby regulate the amplification factor. This capability enhances weak RF signals received by the receiver antenna 126 and prepares them for further processing. In some embodiments, the NPN transistor 130 may be utilized in conjunction with capacitors and resistors to form amplifier circuits tailored to the specific requirements of the RF detection device 102. Capacitors may be used to couple AC signals while blocking DC components, ensuring that only the RF signal is amplified. Resistors set the biasing and operating points of the transistor, optimizing its performance within the circuit 128.

Further, embodiments may include a PNP Darlington transistor 132, which may be a semiconductor device consisting of two PNP transistors 132 connected in a configuration that provides high current gain. The PNP Darlington transistor 132 integrates two stages of amplification in a single package, where the output of the first transistor acts as the input to the second, significantly boosting the overall gain of the circuit 128. The PNP Darlington transistor 132 amplifies weak RF signals received by the receiver antenna 126. The incoming RF signal is fed into the base of the first PNP transistor 132 within the Darlington pair. The PNP Darlington transistor 132, due to its high current gain, allows a much larger current to flow from its collector to the emitter compared to the base current. The output from the collector of the first transistor serves as the input to the base of the second PNP transistor 132 in the Darlington pair. The second PNP transistor 132 further amplifies the signal received from the first stage, again with significant current gain.

Further, embodiments may include an RPN 134, or resistor potentiometer network, which may be an electrical circuit composed of resistors and potentiometers interconnected in a specific configuration to achieve desired electrical characteristics, such as voltage division, signal attenuation, or adjustment of resistance values. Potentiometers, also known as variable resistors, allow for manual adjustment of resistance within the circuit, while resistors set fixed values to control current flow and voltage levels. The RPN 134 in the receiver unit 124 may be configured to adjust signal levels received from the receiver antenna 126 and prepare them for further processing. The RPN 134 consists of resistors and potentiometers connected to achieve precise voltage division and attenuation. By adjusting the potentiometers, operators can fine-tune the signal strength and impedance matching, optimizing signal quality for subsequent stages of signal processing. The RPN 134 ensures that incoming RF signals from the receiver antenna 126 are properly attenuated and scaled to match the input requirements of downstream electronics. This calibration process maintains signal integrity and fidelity throughout the reception and decoding process. In some embodiments, the potentiometers within the RPN 134 may allow for manual adjustment of signal parameters such as amplitude and impedance, enabling operators to optimize signal reception based on environmental conditions and operational requirements.

Further, embodiments may include a tone generator 136, which may be a type of electronic device that produces audio signals or tones to alert the user of specific conditions. The tone generator 136 within the receiver unit 124 is utilized to generate audible alerts when the RF detection device 102 identifies the presence of target materials. The tone generator 136 in the receiver unit 124 may be employed to create specific tones that serve as audible indicators for the user. By generating these tones, the tone generator 136 provides immediate feedback to the operator, signaling the detection of target materials in real time. The tone generator 136 may ensure that the operator is promptly informed of detections without needing to constantly monitor visual displays. The tone generator 136 produces distinct sounds that correspond to different detection events, making it easier for the operator to understand the system's status and respond accordingly. The tone generator 136 may act as a critical alerting component within the receiver unit 124. When the control panel 146 determines that the RF signal corresponds to a detected target material, it sends a signal to the tone generator 136. This triggers the tone generator 136 to produce a sound, alerting the operator to the detection event.

Further, embodiments may include an audio amplifier 138, which may be a type of electronic device designed to increase the amplitude of audio signals. The audio amplifier 138 within the receiver unit 124 may be utilized to boost the audio signals generated by the tone generator 136, ensuring that the output sound is sufficiently loud and clear for the operator to hear. The audio amplifier 138 in the receiver unit 124 may be employed to enhance the volume and clarity of the audio tones produced by the tone generator 136. By amplifying these audio signals, the audio amplifier 138 ensures that the operator receives audible alerts even in noisy environments, thus improving the overall effectiveness of the detection system. The audio amplifier 138 may act as an intermediary component between the tone generator 136 and the output device, such as a speaker. When the tone generator 136 produces an audio signal, this signal is sent to the audio amplifier 138. The audio amplifier 138 then boosts the signal's power, making it strong enough to drive the speaker and produce an audible sound. The audio amplifier 138 is connected to other components within the receiver unit 124, including the tone generator 136 and the speaker. It receives the low-power audio signals from the tone generator 136 and amplifies them to a level suitable for driving the speaker.

Further, embodiments may include a battery 140, which may be a type of energy storage device that provides a stable and portable power source for the receiver unit 124. The battery 140 within the receiver unit 124 may be utilized to supply electrical energy to the various components involved in generating and transmitting the RF signal. The battery 140 may be designed to store electrical energy and supply it to the respective components as required. The battery 140 may be rechargeable or replaceable cells capable of providing DC voltage. They are selected based on factors such as voltage output, and capacity, which may be measured in ampere-hours, Ah, and size to meet the power requirements of each component effectively. In the receiver unit 124, batteries 140 may provide electrical energy to receive and process RF signals detected by the receiver antenna 126. The battery 140 may power components such as amplifiers 138, filters, and signal processing circuitry, enabling the device to analyze incoming RF signals and extract relevant information. In some embodiments, the battery 140 used may include lithium-ion, nickel-metal hydride, or other types suitable for portable electronic devices.

Further, embodiments may include a directional shield 142, which may be a physical barrier or enclosure designed to direct or block electromagnetic radiation in a specific direction. The directional shield 142 may be constructed from conductive materials such as metal to attenuate RF signals, thereby controlling the propagation of electromagnetic waves. The directional shield 142 may be positioned around the RF oscillator 110 and transmitter antenna 120 components and may act as a physical barrier that prevents RF signals from propagating in undesired directions, thereby enhancing the precision and accuracy of signal transmission and reception. During operation, when the transmitter unit 106 generates an RF signal, the directional shield 142 helps to focus and channel this signal towards the intended detection area. By reducing signal dispersion, the directional shield 142 improves the efficiency of signal transmission and enhances the system's overall sensitivity to detecting RF responses from underground objects or materials.

Further, embodiments may include a power supply 144, such as batteries serving as the power source for specific components within the RF detection device 102, including the control panel 146. This power supply 144 may be designed to store electrical energy and supply it to the respective components as required. The power supply 144 for the control panel 146 may be rechargeable or replaceable cells capable of providing DC voltage. The power supply 144 may be selected based on factors such as voltage output, and capacity, which may be measured in ampere-hours, Ah, and size to meet the power requirements of each component effectively. In some embodiments, the control panel 146 may rely on the power supply 144 to maintain functionality for user interface operations, data processing, and communication with other parts of the RF detection device 102. The power supply 144 in the control panel 146 may ensure that it remains operational during field use, supporting tasks such as signal monitoring, parameter adjustment, and data transmission. In some embodiments, the power supply 144 used in these components may include lithium-ion, nickel-metal hydride, or other types suitable for portable electronic devices. The power supply 144 may be integrated into the design to provide sufficient power capacity and longevity, allowing the RF detection device 102 to operate autonomously for extended periods between recharges or replacements.

Further, embodiments may include a control panel 146, which may be a centralized interface comprising electronic controls and displays. The control panel 146 may serve as the user-accessible interface for configuring, monitoring, and managing the RF detection device's 102 operational parameters and data output. In some embodiments, the control panel 146 may be designed to provide operators with intuitive access to control and monitor various aspects of the RF detection device 102. The control panel 146 may allow for the configuration of settings such as signal frequency, transmission power, receiver sensitivity, and signal processing algorithms. In some embodiments, operators may use the control panel 146 to initiate and terminate detection operations, adjust calibration settings, and troubleshoot operational issues. In some embodiments, the control panel 146 may include a graphical display screen or LED indicators to present real-time status information and measurement results. In some embodiments, input controls such as buttons, knobs, or touch-sensitive panels may enable operators to interact with the device, input commands, and navigate through menu options. The control panel 146 may interface directly with the internal electronics of the RF detection device 102, including the transmitter unit 106, receiver unit 124, transmitter antenna 120, receiver antenna 126, and signal processing circuitry. Through electronic connections and communication protocols, the control panel 146 may send commands to adjust operational parameters and receive feedback and status updates from the RF detection device 102. In some embodiments, the control panel 146 may be mounted on the support frame 104 and may provide an operator with control of the RF detection device 102, including adjusting various settings and signaling the operator of a detected material. In some embodiments, a rechargeable power supply 144 may power the RF detection device 102, including the transmitter unit 106, the receiver unit 124, and the control panel 146. In some embodiments, multiple batteries may be used. In some embodiments, a tone generator 136, such as a speaker, may be mounted to the support frame 104 to provide audible signals to the operator for detecting target materials.

Further, embodiments may include a communication interface 148, which may be a hardware and software solution that enables data exchange between different systems or components within a network. The communication interface 148 may act as a bridge, facilitating the transfer of information by converting data into a format that can be transmitted and received by different devices. In some embodiments, the communication interface 148 may support various protocols and standards, such as Ethernet, Wi-Fi, Bluetooth, USB, and others, depending on the application requirements. For example, an Ethernet interface may be used for wired network connections, providing reliable and high-speed data transfer. In some embodiments, a Wi-Fi interface may enable wireless connectivity, allowing the device to communicate with remote servers, mobile devices, or cloud-based applications without physical cables. In some embodiments, Bluetooth and USB interfaces may also be included for short-range wireless communication and direct data transfer, respectively. The communication interface 148 may transmit the processed data from the DSP to external systems for further analysis, reporting, or storage. After the DSP processes the signals received from the ADC and extracts meaningful information about the target materials, the control panel 146 may package this data into suitable formats, such as JSON or XML. The communication interface 148 may then send this data over the network to a remote server or database, where it can be accessed by operators, analysts, or automated systems for further decision-making. In some embodiments, the communication interface 148 may provide remote monitoring and control of the RF detection device 102. Operators may use a web-based interface or a mobile application to access real-time status updates, view detection logs, and adjust configuration settings. For example, if the RF detection device 102 needs to be calibrated for a new target material, the configuration updates can be sent remotely through the communication interface 148, minimizing the need for on-site adjustments. In some embodiments, the communication interface 148 may support alerting and notification functionalities. When the control panel 146 detects the presence of target materials, it can use the communication interface 148 to send immediate alerts to designated personnel via email, SMS, or push notifications.

Further, embodiments may include a processor 150, which may be responsible for executing instructions from programs and controlling the operation of other hardware components. The processor 150 may perform basic arithmetic, logic, control, and input/output (I/O) operations specified by the instructions in the programs. The processor 150 may operate by fetching instructions from memory 152, decoding them to determine the required operation, executing the operations, and then storing the results. In some embodiments, the processor 150 may coordinate the overall system operations, manage communication between subsystems, and handle complex data analysis tasks that complement the real-time signal processing performed by the DSP. For example, when the RF detection device 102 is powered on, the processor 150 may initiate a boot-up sequence that includes running diagnostics to check the status of all subsystems, such as the transmitter unit 106, receiver unit 124, and control panel 146. During this initialization phase, the processor 150 may ensure that each component receives the correct voltage and current levels required for operation. The processor 150 may also load predefined detection configurations and communicate with the transmitter unit 106 and receiver unit 124 to configure their operating parameters based on the target material. In some embodiments, the processor 150 may handle user interface tasks, displaying system status indicators and receiving user inputs. The processor 150 may ensure that the control panel 146 provides real-time feedback, such as green LED indicators for successful power-up and system readiness. In some embodiments, the processor 150 may manage data storage and logging, recording detection events and system performance metrics for future analysis.

Further, embodiments may include a user interface 152, which may be a graphical and interactive interface that enables users to control, monitor, and interact with the RF detection device 102 functionalities. The user interface 152 may provide a means for selecting target materials, configuring operational parameters, initiating the detection process, and receiving real-time feedback and analysis results. In some embodiments, the user interface 152 may include visual indicators, control buttons, data visualization tools, and user guidance components to facilitate efficient and accurate detection and analysis of specific materials. In some embodiments, the user interface 152 may display notifications, alerts, messages, etc., to inform the user or operator of detected target materials, analysis of the detected target material, etc.

Further, embodiments may include a memory 152, which may include suitable logic, circuitry, and/or interfaces that may be configured to store a machine code and/or a computer program with at least one code section executable by the processor 150. Examples of implementation of the memory 152 may include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions. In some embodiments, the memory 152 may store configuration settings, signal patterns, and detection algorithms.

Further, embodiments may include a base module 156, which begins when the system is activated and the user selects the target material. The base module 156 compares the inputted target material to the specific material database 166 and extracts the frequency data and power data from the specific material database 166. The base module 156 sends the extracted frequency data and power data to the detection module 158 and initiates the detection module 158. The base module 156 determines if the target material was detected by the detection module 158. If it is determined that the detection module 158 did not detect the target material the base module 156 returns to the user inputting the target material. If it is determined that the detection module 158 detected the target material, the base module 156 stores the data in the probability database 168 and initiates the LLM module 160 and the probability module 164.

Further, embodiments may include a detection module 158, which begins by being initiated by the base module 156 and receives the frequency data from the base module 156. The detection module 158 commands the transmitter unit 106 to configure the transmit signal and then generate the transmit signal via the transmit antenna 120. The detection module 158 commands the receiver unit 124 to receive the RF signal via receiver antenna 126. The detection module 158 commands the receiver unit 124 to process the RF signal and sends the output to the base module 156. The detection module 158 returns to the base module 156.

Further, embodiments may include an LLM module 160, which begins by being initiated by the base module 156. The LLM module 160 extracts the target material from the probability database 168 and performs a large language model, or LLM, on the target material. The LLM module 160 stores the output of the large language model in the probability database 168 and initiates the enhance module 162. The LLM module 160 returns to the base module 156.

Further, embodiments may include an enhance module 162, which begins by being initiated by the LLM module 160. The enhance module 162 extracts the first related material from the probability database 168 and compares the extracted related material to the specific material database 166. The enhance module 162 extracts the frequency data from the specific material database 166. The enhance module 162 commands the transmitter unit 106 to configure the transmit signal and to generate the transmit signal via the transmit antenna 120. The enhance module 162 commands the receiver unit 124 to receive the RF signal and to process the RF signal. The enhance module 162 commands the receiver unit 124 to store the output in the probability database 168. The enhance module 162 determines if there are more related materials stored in the probability database 168. If it is determined that there are more related materials stored in the probability database 168 the enhance module 162 extracts the next related material, and the process returns to comparing the related to the specific material database 166. If it is determined that there are no more related materials stored in the probability database 168, the enhance module 162 returns to the LLM module 160.

Further, embodiments may include a probability module 164, which begins by being initiated by the base module 156. The probability module 164 extracts the data from the probability database 168 and performs the probability algorithm. The probability module 164 sends the output to the user interface 152 and returns to the base module 156.

Further, embodiments may include a specific material database 166, which may store and manage detailed information about various target materials. The specific material database 166 may be used to configure the detection parameters to identify specific materials based on their unique electromagnetic properties. Each entry in the database may be defined by the material's atomic structure, which includes the total number of protons and neutrons. The unique nuclear composition allows each substance to be distinctly identifiable and detectable through its resonant frequency. The specific material database 166 may contain a unique Material ID, the common name of the material, the number of protons, the number of neutrons, and the atomic mass, which is the sum of protons and neutrons. The specific material database 166 may also contain calculated resonant frequencies based on the atomic characteristics. The resonant frequencies are critical for configuring the transmitter unit of the RF detection device 102, which sends out signals at these specific frequencies to induce a resonant response in the target material. For example, the specific material database 166 may contain an entry for Arsenic (As) with 33 protons and 42 neutrons, resulting in an atomic mass of 75. The resonant frequencies for Arsenic could be 33 Hz, based on the number of protons, 42 Hz, based on the number of neutrons, and 75 Hz, based on the atomic mass. These frequencies may also be increased by orders of magnitude, such as 10× or 100×, to suit different detection environments. In some embodiments, for compounds, the specific material database 166 calculates a combined frequency based on the sum of the resonant frequencies of the constituent elements. For example, a Formaldehyde molecule, composed of 16 protons and 14 neutrons with a total atomic mass of 30, would have corresponding frequencies of 16 Hz, 14 Hz, and 30 Hz, respectively. Another example may be smokeless gunpowder, specifically nitroglycerin, with the chemical composition CH2NO3CHNO3CH2NO3. The frequency for this compound may be calculated by summing the frequencies based on the atomic numbers of its constituent elements: 6 carbon +1×2 hydrogen +7 nitrogen +8×3 oxygen, repeated thrice, resulting in a total of 116 protons. This is then multiplied by 10 to yield a base frequency of 1160 Hz for detection purposes. In some embodiments, the specific material database 166 may account for overlapping frequencies among different elements and compounds. To enhance the accuracy of detection, the system may employ multiple methods to calculate and verify the target material's frequency, such as using combinations of proton counts, neutron counts, and atomic masses, which allows the system to distinguish between materials with similar frequencies by leveraging the unique resonant properties of each substance.

Further, embodiments may include a probability database 168, which may be created from the processes described in the base module 156, LLM module 160, and enhance module 162 and may be used by the probability module 164 to determine if the target material was detected. The probability database 168 may include the target material, the associated frequencies and power levels of the target material if the target material was detected for each frequency and power level, the plurality of related materials, the associated frequencies and power levels for the related materials, if the related materials were detected for each frequency and power level, etc. For example, the probability algorithm may use the extracted data from the probability database 168, such as the target material's name, its associated frequencies, and power levels, detection status for each frequency and power level, related materials, their respective frequencies and power levels, and the detection status for each frequency and power level of the related materials. The probability algorithm may assign a base probability value to the detection of the target material, such as a default low probability to ensure that further calculations can appropriately adjust it based on additional evidence. The probability algorithm then analyzes whether the target material was detected at its specific frequencies and power levels. The probability algorithm checks each frequency and power level combination recorded in the probability database 168 and notes the detection status. For example, the probability algorithm may check a Boolean or binary flag that indicates detection status, such as detected=true/false. Next, the probability algorithm may examine the detection status of related materials. The probability algorithm looks at the frequencies and power levels associated with each related material and determines if these related materials were detected, which may involve iterating through each related material and checking their detection records. The probability algorithm may adjust the initial probability of the target material being correctly identified based on the detection of related materials. Each detected related material positively influences the probability. The more related materials detected, the higher the confidence in the correct identification of the target material. The probability algorithm may aggregate the influences from all detected related materials and normalize the final probability score to ensure it is within a reasonable range, for example, 0 to 1 or 0% to 100%. The probability algorithm outputs the probability score, which represents the likelihood that the target material was correctly identified. In some embodiments, the score may be used for further decision-making or displayed to the user. For example, the probability algorithm may use a Rainforest probability function, which is a method that can handle multiple variables and their interactions to determine a probability score. If the probability algorithm is trying to determine the probability of the detection of uranium, the algorithm retrieves data for uranium, including its detection frequencies, such as 50 Hz, 100 Hz, etc., and power levels. The algorithm may also retrieve data for related materials like radon, thorium, and lead, including their detection frequencies and power levels. The initial probability for uranium detection may be set to a low value, such as 10%. The probability algorithm checks if uranium was detected at 50 Hz and 100 Hz across various power levels. For example, uranium may be detected at both frequencies and multiple power levels. The probability algorithm may check the detection status of radon, thorium, and lead at their respective frequencies and power levels. For example, radon and thorium may be detected, but lead is not. Each detected related material, such as radon and thorium, increases the probability score. For example, detecting radon might add 15% and thorium another 20%, resulting in a cumulative probability increase. The total contributions from related materials are summed and normalized. In some embodiments, if the cumulative score exceeds 100%, it may be scaled back to fit within the 0 to 100% range. The final probability score is output, indicating a high likelihood, such as 80%, that uranium is correctly identified, based on the detection of uranium itself and the related materials, such as radon and thorium.

Further, embodiments may include a cloud 170, or communication network, which may be a wired and/or wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet, and relies on the sharing of resources to achieve coherence and economies of scale, like a public utility, while third-party clouds 170 enable organizations to focus on their core businesses instead of expending resources on computer infrastructure and maintenance.

Further, embodiments may include a network 176, which may be a collection of interconnected devices that communicate with each other to share resources, data, and applications. In some embodiments, the network 176 may utilize various protocols, such as TCP/IP, to ensure data is transmitted accurately and efficiently. In some embodiments, the network 176 may transmit the processed data from the DSP to user devices, allowing operators to view and analyze the data collected. The network 176 may be designed to support real-time data transmission, remote monitoring, and analysis functionalities, ensuring that the system operates efficiently and effectively. Upon receiving the processed signals from the DSP, the control panel 146 may package the data into standardized formats such as JSON or XML, making it suitable for transmission over the network 176. In some embodiments, the network 176 setup may involve an Ethernet or Wi-Fi interface integrated into the control panel 146, which establishes a connection to the local network or the internet. For example, when the control panel 146 detects the presence of target materials, it sends the relevant data to the server or cloud platform via the network 176. The data is then processed and stored, allowing operators to access it through their user devices. For example, if the RF detection device 102 identifies a hazardous material, the data is immediately transmitted to the cloud platform, where it triggers alerts and notifications to the operators'devices. Operators can then log into the platform, view detailed reports, and analyze the data to make informed decisions. In some embodiments, the 3rd party network 172 may send the LLM model to the LLM module 160 and the probability algorithm to the probability module 164 to allow the RF detection device 102 to perform enhanced detection processes. In some embodiments, the 3rd party network 172 may receive the outputs of the LLM model and probability algorithm to update and further train the model and algorithm.

In another embodiment, a material detection system uses a hybrid antenna that can operate both in RF-based and magnetic-based detection modes. This system is capable of switching between detecting materials based on their interaction with the RF field or the magnetic field, depending on the material being analyzed. In RF mode, the antenna transmits RF waves, and the system analyzes how the material reflects or absorbs these waves, providing information based on the dielectric constant or conductive properties of the material. In magnetic mode, the antenna focuses on the interaction between the material and the magnetic field component of the electromagnetic wave, allowing detection of materials with high magnetic permeability or strong magnetic responses. For example, the system could be used to detect metallic substances or magnetic compounds, such as those found in explosive materials, by optimizing the detection process based on which field interaction yields the clearest signature.

In yet another embodiment, a near-field material detection system uses a magnetic-based loop antenna that focuses on magnetic field interaction within close proximity to the target material. This system uses magnetic resonance principles, detecting changes in the magnetic field due to interactions with materials possessing magnetic susceptibility, such as ferromagnetic metals. The loop antenna generates a localized oscillating magnetic field, and when materials are introduced into the detection zone, they alter the field by inducing eddy currents or magnetic resonance effects. These changes are then measured to determine the material's properties. This method is particularly useful in applications such as industrial quality control or close-range security screening, where detecting the magnetic characteristics of a material offers clear advantages.

In still another embodiment, far-field magnetic resonance techniques are employed for material detection at greater distances. This system operates by transmitting an electromagnetic wave where the magnetic field component is emphasized, focusing on its interaction with materials that have resonant magnetic properties. By tuning the system to specific resonant frequencies, materials that exhibit strong magnetic responses, such as certain alloys or ferromagnetic materials, can be detected over a larger range. The detection system then analyzes the phase or amplitude of the reflected wave to infer material characteristics. This embodiment is particularly suitable for remote sensing applications, such as geological surveys, where materials can be identified based on their magnetic resonance even when located at a distance from the detection apparatus.

In other embodiments, an array of antennas is used to simultaneously detect materials based on both RF and magnetic field interactions. The antenna array consists of dipole antennas optimized for detecting the electric component of the RF wave and loop antennas that focus on the magnetic field interaction. These two types of signals are combined to create a composite material signature, allowing for detailed analysis of both the dielectric and magnetic properties of the material. By processing both electric and magnetic field data, the system can more accurately identify materials that exhibit a combination of electrical conductivity and magnetic permeability, such as advanced composites or stealth materials. This dual-mode system can be particularly useful in defense or aerospace applications.

In still other embodiments, a magnetic-based antenna system is designed for material detection in environments where RF signals would typically be degraded, such as underground or underwater. This system uses a loop antenna to generate a magnetic field that interacts with materials possessing strong magnetic properties, even in situations where RF signals are heavily attenuated. The antenna detects variations in the magnetic field caused by materials with high permeability, such as iron or nickel-based substances. This method allows for the detection of magnetic materials in conditions where RF detection would be unreliable, such as in deep-sea exploration or subterranean mining operations, where conventional RF signals would fail to penetrate effectively.

In further embodiments, a phased array system is designed specifically to manipulate the magnetic component of the electromagnetic wave for high-resolution material detection. A phased array of loop antennas is used to steer and focus the magnetic field, creating a directed magnetic beam that can scan across a target area. The system detects materials based on how they alter the magnetic field, allowing for precise location and identification of magnetic objects. By adjusting the phase and amplitude of each antenna element, the system provides a fine degree of control, enabling highly localized material detection. This approach is useful in situations requiring detailed spatial resolution, such as identifying hidden metallic objects in security screening or detailed inspections in industrial settings.

In additional embodiments, a portable or wearable material detection system is implemented using a small, magnetic-based loop antenna for detecting magnetic materials in close proximity. This compact system allows security personnel or industrial workers to move through different environments while continuously monitoring for materials that exhibit magnetic properties. The loop antenna generates a localized magnetic field and detects perturbations caused by nearby magnetic materials, such as concealed weapons or magnetic tags. The system then alerts the user when such materials are detected, making it ideal for field operations where mobility and ease of use are critical.

In yet another embodiment, the material detection system is entirely RF-based, using a highly optimized RF antenna to detect materials based solely on their interaction with the RF field. The RF antenna transmits electromagnetic waves at specific frequencies, and the system analyzes how these waves are reflected, absorbed, or scattered by the material. By focusing on the dielectric constant or conductive properties of the target material, the system can accurately identify substances such as explosives, chemicals, or other dielectric materials. This approach is particularly effective in environments where magnetic field-based detection is unnecessary or less effective. The RF-based system can be adapted for wide-ranging applications, from industrial material testing to security scanning, where detecting the electrical characteristics of the material is sufficient for identification.

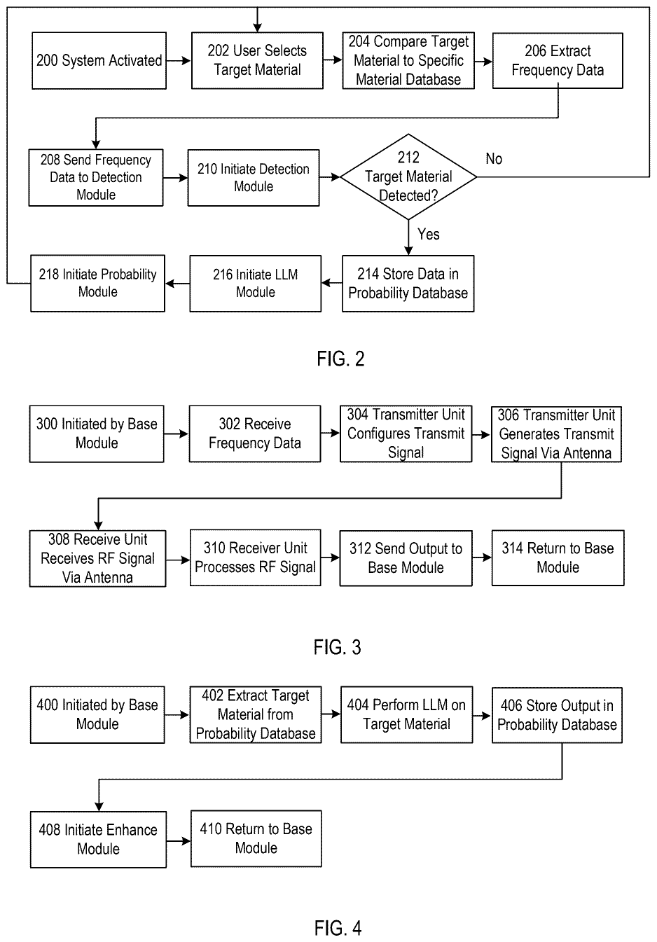

FIG. 2 is a flow chart of a method performed by the base module 156. The process begins with the system being activated at step 200. The base module 156 may begin with the RF detection device 102 being activated by the user or operator. The user selects, at step 202, the target material. The user may select the target material through the user interface 152 by searching the specific material database 166 for a material of interest. The base module 156 compares, at step 204, the inputted target material to the specific material database 166. The specific material database 166 may be used to configure the detection parameters to identify specific materials based on their unique electromagnetic properties. Each entry in the database may be defined by the material's atomic structure, which includes the total number of protons and neutrons. The unique nuclear composition allows each substance to be distinctly identifiable and detectable through its resonant frequency. The specific material database 166 may contain a unique material ID, the common name of the material, the number of protons, the number of neutrons, and the atomic mass, which is the sum of protons and neutrons. The specific material database 166 may also contain calculated resonant frequencies based on the atomic characteristics. The resonant frequencies are critical for configuring the transmitter unit of the RF detection device 102, which sends out signals at these specific frequencies to induce a resonant response in the target material. For example, the specific material database 166 may contain an entry for Arsenic (As) with 33 protons and 42 neutrons, resulting in an atomic mass of 75. The resonant frequencies for Arsenic could be 33 Hz, based on the number of protons, 42 Hz, based on the number of neutrons, and 75 Hz, based on the atomic mass. These frequencies may also be increased by orders of magnitude, such as 10× or 100×, to suit different detection environments. In some embodiments, for compounds, the specific material database 166 calculates a combined frequency based on the sum of the resonant frequencies of the constituent elements. For example, a Formaldehyde molecule, composed of 16 protons and 14 neutrons with a total atomic mass of 30, would have corresponding frequencies of 16 Hz, 14 Hz, and 30 Hz, respectively. Another example may be smokeless gunpowder, specifically nitroglycerin, with the chemical composition CH2NO3CHNO3CH2NO3. The frequency for this compound may be calculated by summing the frequencies based on the atomic numbers of its constituent elements: 6 carbon +1×2 hydrogen +7 nitrogen +8×3 oxygen, repeated thrice, resulting in a total of 116 protons. This is then multiplied by 10 to yield a base frequency of 1160 Hz for detection purposes. In some embodiments, the specific material database 166 may account for overlapping frequencies among different elements and compounds. To enhance the accuracy of detection, the system may employ multiple methods to calculate and verify the target material's frequency, such as using combinations of proton counts, neutron counts, and atomic masses, which allows the system to distinguish between materials with similar frequencies by leveraging the unique resonant properties of each substance. The base module 156 extracts, at step 206, the frequency data and power data from the specific material database 166. In some embodiments, the base module 156 may extract additional transmission parameters, including power levels, modulation, filtering, etc. In some embodiments, each target material may have a plurality of frequencies and power levels that the base module 156 may send to the detection module 158 to loop through to determine if the target material is identified. For example, for an individual element, there may be frequencies associated with the number of protons, number of neutrons, and atomic mass of the element, allowing the detection module 158 to transmit and receive an RF signal for each potential frequency to determine if the target material, or in this case the material related to the target material, has been detected. The base module 156 sends, at step 208, the extracted frequency data and power data to the detection module 158. In some embodiments, the base module 156 may send additional transmission parameters, including power levels, modulation, filtering, etc. In some embodiments, each target material may have a plurality of frequencies and power levels that the base module 156 may send to the detection module 158 to loop through to determine if the target material is identified. For example, for an individual element, there may be frequencies associated with the number of protons, number of neutrons, and atomic mass of the element, allowing the detection module 158 to transmit and receive an RF signal for each potential frequency to determine if the target material, or in this case the material related to the target material, has been detected. The base module 156 initiates, at step 210, the detection module 158. The detection module 158 begins by being initiated by the base module 156 and receives the frequency data from the base module 156. The detection module 158 commands the transmitter unit 106 to configure the transmit signal and then generate the transmit signal via the transmit antenna 120. The detection module 158 commands the receiver unit 124 to receive the RF signal via receiver antenna 126. The detection module 158 commands the receiver unit 124 to process the RF signal and sends the output to the base module 156. The detection module 158 returns to the base module 156. The base module 156 determines, at step 212, if the target material was detected by the detection module 158. If it is determined that the detection module 158 did not detect the target material the base module 156 returns to the user inputting the target material. If it is determined that the detection module 158 detected the target material, the base module 156 stores, at step 214, the data in the probability database 168. The base module 156 may store the target material and the associated frequencies and power levels of the target material in the probability database 168. The base module 156 initiates, at step 216, the LLM module 160. The LLM module 160 begins by being initiated by the base module 156. The LLM module 160 extracts the target material from the probability database 168 and performs a large language model, or LLM, on the target material. The LLM module 160 stores the output of the large language model in the probability database 168 and initiates the enhance module 162. The LLM module 160 returns to the base module 156. The base module 156 initiates, at step 218, the probability module 164. The probability module 164 begins by being initiated by the base module 156. The probability module 164 extracts the data from the probability database 168 and performs the probability algorithm. The probability module 164 sends the output to the user interface 152 and returns to the base module 156. In some embodiments, the probability module 164 may return to the user selecting the target material.

FIG. 3 is a flow chart of a method performed by the detection module 158. The process begins with the detection module 158 being initiated, at step 300, by the base module 156. The detection module 158 receives, at step 302, the frequency data from the base module 156. In some embodiments, the detection module 158 may receive additional transmission parameters, including power levels, modulation, filtering, etc. In some embodiments, each target material may have a plurality of frequencies that the detection module 158 may loop through to determine if the target material is identified. For example, the selected frequencies for Arsenic (As) would be 33 Hz, based on the number of protons, 42 Hz, based on the number of neutrons, and 75 Hz, based on atomic mass. These frequencies can also be increased by one or more orders of magnitude, such as 10×, 100×, etc. Similarly, the frequencies for a compound can be selected based on the sum total of the constituent parts. For example, a Formaldehyde molecule has a combined total of 16 protons, corresponding to a frequency of 16 Hz, 14 neutrons, corresponding to a frequency of 14 Hz, and a mass of 30, corresponding to a frequency of 30 Hz. Individual scans using two or more of these frequencies can be used to uniquely identify the element or compound. In some embodiments, a frequency is selected for a particular element based on the sum of the number of protons and atomic mass, such as the sum of protons and neutrons, for the element. For example, the selected frequency for Arsenic (As) would be 108 Hz based on the addition of 33 protons, with 75 atomic mass. This frequency can also be increased by one or more orders of magnitude, such as 10×, 100×, etc. Similarly, the frequency for a compound can be selected based on the sum total of the constituent parts. For example, a Formaldehyde molecule has a combined total of 16 protons and a mass of 30. The corresponding frequency would be 46 Hz, addition of 16 protons with 30 mass. As another example, smokeless gunpowder would yield a base transmit frequency of 1160. The tuning frequency of 1160 Hz is derived from the chemical composition, discrete atomic structure, CH2NO3CHNO3CH2NO3 for nitroglycerin. By using the atomic number, or the number of protons for each element, the frequency is calculated as 6+(1*2)+7+(8*3)+6+1+7+(8*3)+6+(1*2)+7+(8*3) which yields a sum of 116 protons in the compound. This is then increased by an order of magnitude, such as 10×, yielding 1160 Hz as the frequency to search for nitroglycerin. In some embodiments, some elements and compounds may have overlapping frequencies using only one of the methods described above, and it may be beneficial to use multiple of the above-described methods when searching for or identifying a target material. In some embodiments, the detection module 158 may use a plurality of power levels of the transmitted signal to determine if the target material is detected or not. The detection module 158 commands, at step 304, the transmitter unit 106 to configure the transmit signal. The transmitter unit 106 prepares the signal that will be transmitted for the purpose of detecting a target material. In some embodiments, the parameters and components may be set up with the desired characteristics to generate the RF signal. The control panel 146 determines the specific parameters of the RF signal that need to be generated. The parameters may include the frequency, amplitude, and modulation type required to effectively detect the target materials. Once the parameters are set, the control panel 146 sends a command to activate the oscillator circuit 108 within the transmitter unit 106. The oscillator circuit 108 may be responsible for generating a stable RF signal at the desired frequency and may consist of components like capacitors, inductors, and amplifiers that work together to create the oscillating signal. The power delivery to the oscillator circuit 108 may be managed by the SCR 114. When the control panel 146 sends a gate signal to the SCR 114, it switches from a non-conductive to a conductive state, allowing current from the power source, such as batteries, to flow to the oscillator circuit 108. After the oscillator circuit 108 generates the RF signal, the transformer 116 adjusts the voltage level of the signal to match the requirements of the transmit antenna 120. It may also provide impedance matching to ensure efficient signal transmission. The transformer 116 ensures that the RF signal is at the appropriate voltage and current levels for optimal transmission. For example, the control panel 146 may determine that an RF signal with a frequency of 50 Hz is required to detect a specific material. It sends a command to the transmitter unit 106 to configure this signal. The oscillator circuit 108 is activated, generating an RF signal at 50 Hz. The SCR 114 is triggered, allowing power from the batteries 122 to flow to the oscillator circuit 108. The generated signal is then conditioned by the transformer 116, ensuring it is at the correct voltage level for transmission. The detection module 158 commands, at step 306, the transmitter unit 106 to generate the transmit signal via the transmit antenna 120. The transmitter unit 106 generates the RF signal and transmits it through the transmit antenna 120 by converting electrical energy into radio waves that can be used for detecting specific materials. The transmit antenna 120 radiates the RF signal into the environment. The radio waves propagate through the medium, such as air or ground, and interact with the target materials. The interaction between the RF signal and the target materials will produce detectable changes in the signal, which can be received and analyzed by the receiver unit 124. For example, the transmitter unit 106 generates a wave pulse at a specified frequency that is transmitted directionally into the ground. The generated frequency is closely approximate or exact to that of the target material, and that relationship creates a responsive RF wave and/or a magnetic line between the transmitter antenna 120 and the target. When the RF detection device 102 is aligned with a target material, for example, when the opening of the directional shield 142 is pointing toward the target material, the voltage produced by the receiver antenna 126 changes and thereby produces a detection output signal, such as an audio signal having a tone different than that of the baseline. A reflective wave is produced by the target material that amplifies, resonates, offsets, or otherwise modifies the magnetic field passing through the receiver antenna 126 to alter the voltage produced, thereby generating the output signal. The receiver antenna 126 is responding to a voltage increase from the transmitter antenna 120 swinging over the magnetic line to the material. The detection module 158 commands, at step 308, the receiver unit 124 to receive the RF signal via receiver antenna 126. The receiver unit 124 captures the RF signal that has interacted with the environment and potential target materials using the receiver antenna 126. The receiver antenna 126 captures the incoming RF signal, which has been transmitted by the transmitter unit 106 and has interacted with the environment and any target materials present. The receiver antenna 126 may be designed to effectively capture these radio waves and convert them back into electrical signals. Once the RF signal is received by the receiver antenna 126, it may be fed into an RF amplifier, which boosts the signal strength without significantly altering its characteristics. In some embodiments, the use of the standard atomic structure of a material may be used to calculate the resonant frequency to which a particular substance would generate or respond. Each element and compound comprises a definable atomic structure composed of the total number of protons and neutrons of that target material. This unique nuclear composition of every substance makes it uniquely identifiable and detectable. The manner in which this information is applied thus enables the detection of any target substance. A target material can be detected and located based on a resonant, responsive RF wave and/or magnetic relationship between the target and a transmitter antenna 120 transmitting at a frequency specific and unique to the target material. The transmitter unit 106, through the transmitter antenna 120, induces a resonance due to responsive RF waves and/or magnetic and/or otherwise in a targeted material to resonate at a specific computed frequency. The receiver antenna 126 and receiver circuit 128 detect the resonance induced in the material and, in so doing, indicate the approximate line of bearing to the material. The primary method used by this detection system to detect specific materials is based on tuning the circuit 108 of the transmitter unit 106 to a specific value that is computed for the material of interest. The frequency can be based on any of the three defining characteristics of the substance, the number of protons, the number of neutrons, or the atomic mass, such as the sum of protons and neutrons and combinations thereof. The frequency can be transmitted at varying voltages to compensate for other external effects or interference. In some embodiments, a table or database of characteristics of common materials may be used to calculate the resonant frequencies. To accomplish this tuning, the frequency of the signal from the transmitter antenna 120 is set to some harmonic of the elements of the material. The detection module 158 commands, at step 310, the receiver unit 124 to process the RF signal. The receiver unit 124 processes the received RF signal to extract meaningful data that can be analyzed for the presence of specific materials, which may involve further amplification, filtering, digitization, and initial data processing before the signal is sent to the control panel 146 for detailed analysis. In some embodiments, after the RF signal is received and initially amplified, it may require further amplification to ensure the signal is at an optimal level for processing. In some embodiments, an additional RF amplifier within the receiver unit 124 may boost the signal strength while maintaining its integrity. The amplified signal may be subjected to more advanced filtering by the filter circuit, which removes any residual noise and unwanted frequencies that might have passed through the initial filtering stage. In some embodiments, the filtering may involve bandpass filters that allow only the desired frequency range to pass through. The filtered analog signal may be converted into a digital format using an Analog-to-Digital Converter, ADC. The ADC samples the analog signal at a high rate and converts it into a series of digital values. The digitized signal may be processed using digital techniques. The digital signal may be fed into a Digital Signal Processor, DSP, within the receiver unit 124. In some embodiments, the DSP may perform initial data processing tasks such as demodulation, noise reduction, and feature extraction. Demodulation involves extracting the original information-bearing signal from the carrier wave. Noise reduction techniques may further clean the signal, making it easier to analyze. Feature extraction may involve identifying characteristics of the signal that are indicative of the presence of target materials. The detection module 158 sends, at step 312, the output to the base module 156. The receiver unit 124 transmits the processed data to the base module 156 for further analysis and decision-making, which may involve packaging the data in a suitable format, establishing a communication link, and ensuring the accurate and secure transmission of the data from the receiver unit 124 to the base module 156. The resultant data from the DSP process is organized and packaged, which may involve structuring the data into packets, adding metadata such as timestamps and identifiers, and incorporating error-checking codes to ensure data integrity during transmission. In some embodiments, the digital data packets may be converted into a format suitable for transmission. The detection module 158 returns, at step 314, to the base module 156.

FIG. 4 is a flow chart of a method performed by the LLM module 160. The process begins with the LLM module 160 being initiated, at step 400, by the base module 156. The LLM module 160 extracts, at step 402, the target material from the probability database 168. The LLM module 160 may extract the target material and its associated frequencies and power levels from the probability database 168. The LLM module 160 performs, at step 404, a large language model, or LLM, on the target material. For example, a previously created dataset that includes information on various materials, their properties, and their associations may be stored on the RF detection device 102. In some embodiments, the data may be collected from scientific databases, research papers, textbooks, and industry reports. Once collected, the data may be cleaned by removing duplicates, correcting inconsistencies, and filtering out irrelevant information. The cleaned data is then structured into a database or formatted files with well-defined fields such as material name, properties, related materials, and context. The LLM model may be a pre-trained Bidirectional Encoder Representations from Transformers (BERT) model, such as BERT-Base or BERT-Large, from the Hugging Face library. The environment is set up by installing the necessary libraries, such as the Transformers library from Hugging Face to ensure that the BERT model is ready for processing the data and determining related materials. The LLM module 160 automatically extracts the target material from the probability 168 database. For example, if the target material is uranium, the LLM module identifies “uranium” and retrieves its related context from the database. The LLM model processes the extracted target material to determine related materials, such as feeding the target material's context into the BERT model, which then generates a list of related materials based on its understanding. For instance, if the target material is uranium, the BERT model might identify radon, thorium, lead, zircon, and phosphates as related materials. If the target is a cancerous tumor, related materials might include precancerous cells, inflammatory cells, stromal cells, blood vessels, and healthy cells. For gunpowder in an explosive device, related materials might be sulfur, charcoal, potassium nitrate, detonators, fuses, shrapnel materials, and casing materials. After the BERT model generates the list of related materials, the system analyzes the responses to extract meaningful information. Natural language processing techniques are used to identify phrases and relationships to ensure that the extracted related materials are contextually relevant and scientifically accurate. In some embodiments, the extracted information may be cross-referenced with authoritative sources to validate its accuracy, such as checking the related materials against scientific literature and databases to ensure they are correct and relevant. For example, confirming that radon and thorium are indeed commonly found near uranium in nature. Other examples include layered material detection where the LLM module 160 may identify common packaging materials associated with smuggling narcotics. For instance, cocaine often wrapped in plastic or aluminum foil may be identified by detecting the frequencies associated with cocaine and also with plastic or aluminum. Environmental context detection may involve detecting traces of explosives along with common soil elements to differentiate between naturally occurring substances and those that are foreign. Multi-component chemical detection may include identifying chemical warfare agents alongside stabilizers or preservatives used in their formulation to improve detection reliability in varied environments. For industrial applications, the system may detect pipeline leaks by identifying the primary substance, such as methane, along with secondary markers like pipe material, such as steel or PVC. Biological material detection in medical diagnostics may involve identifying biological markers alongside common environmental markers in clinical settings, such as detecting glucose levels in the presence of common disinfectants used in hospitals. The LLM module 160 stores, at step 406, the output of the large language model in the probability database 168. The LLM module 160 stores the related materials identified by the LLM model in the probability database 168. The LLM module 160 initiates, at step 408, the enhance module 162. The enhance module 162 begins by being initiated by the LLM module 160. The enhance module 162 extracts the first related material from the probability database 168 and compares the extracted related material to the specific material database 166. The enhance module 162 extracts the frequency data from the specific material database 166. The enhance module 162 commands the transmitter unit 106 to configure the transmit signal and to generate the transmit signal via the transmit antenna 120. The enhance module 162 commands the receiver unit 124 to receive the RF signal and to process the RF signal. The enhance module 162 commands the receiver unit 124 to store the output in the probability database 168. The enhance module 162 determines if there are more related materials stored in the probability database 168. If it is determined that there are more related materials stored in the probability database 168 the enhance module 162 extracts the next related material, and the process returns to comparing the related to the specific material database 166. If it is determined that there are no more related materials stored in the probability database 168, the enhance module 162 returns to the LLM module 160. The LLM module 160 returns, at step 410, to the base module 156.

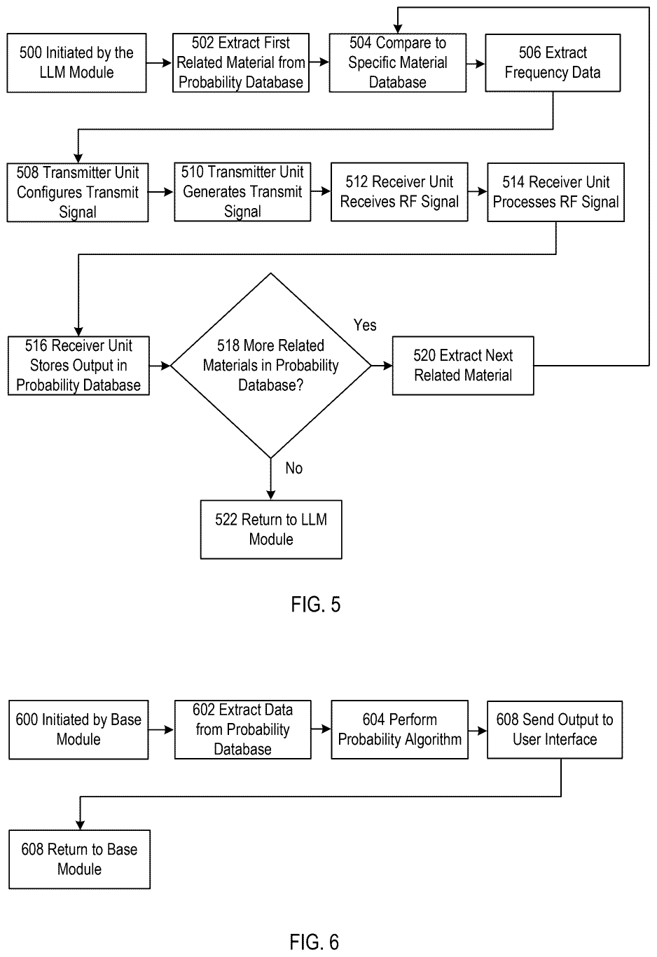

FIG. 5 is a flow chart of a method performed by the enhance module 162. The process begins with the enhance module 162 being initiated, at step 500, by the LLM module 160. The enhance module 162 extracts, at step 502, the first related material from the probability database 168. The probability database 168 may contain the materials related to the target material that were identified by the LLM model in the LLM module 160. The enhance module 162 compares, at step 504, the extracted related material to the specific material database 166. The specific material database 166 may be used to configure the detection parameters to identify specific materials based on their unique electromagnetic properties. Each entry in the database may be defined by the material's atomic structure, which includes the total number of protons and neutrons. The unique nuclear composition allows each substance to be distinctly identifiable and detectable through its resonant frequency. The specific material database 166 may contain a unique Material ID, the common name of the material, the number of protons, the number of neutrons, and the atomic mass, which is the sum of protons and neutrons. The specific material database 166 may also contain calculated resonant frequencies based on the atomic characteristics. The resonant frequencies are critical for configuring the transmitter unit of the RF detection device 102, which sends out signals at these specific frequencies to induce a resonant response in the target material. For example, the specific material database 166 may contain an entry for Arsenic (As) with 33 protons and 42 neutrons, resulting in an atomic mass of 75. The resonant frequencies for Arsenic could be 33 Hz, based on the number of protons, 42 Hz, based on the number of neutrons, and 75 Hz, based on the atomic mass. These frequencies may also be increased by orders of magnitude, such as 10× or 100×, to suit different detection environments. In some embodiments, for compounds, the specific material database 166 calculates a combined frequency based on the sum of the resonant frequencies of the constituent elements. For example, a Formaldehyde molecule, composed of 16 protons and 14 neutrons with a total atomic mass of 30, would have corresponding frequencies of 16 Hz, 14 Hz, and 30 Hz, respectively. Another example may be smokeless gunpowder, specifically nitroglycerin, with the chemical composition CH2NO3CHNO3CH2NO3. The frequency for this compound may be calculated by summing the frequencies based on the atomic numbers of its constituent elements: 6 carbon+1×2 hydrogen+7 nitrogen+8×3 oxygen, repeated thrice, resulting in a total of 116 protons. This is then multiplied by 10 to yield a base frequency of 1160 Hz for detection purposes. In some embodiments, the specific material database 166 may account for overlapping frequencies among different elements and compounds. To enhance the accuracy of detection, the system may employ multiple methods to calculate and verify the target material's frequency, such as using combinations of proton counts, neutron counts, and atomic masses, which allows the system to distinguish between materials with similar frequencies by leveraging the unique resonant properties of each substance. The enhance module 162 extracts, at step 506, the frequency data from the specific material database 166. In some embodiments, the enhance module 162 may extract additional transmission parameters, including power levels, modulation, filtering, etc. In some embodiments, each target material may have a plurality of frequencies and power levels that the enhance module 162 may loop through to determine if the target material is identified. For example, for an individual element, there may be frequencies associated with the number of protons, number of neutrons, and atomic mass of the element, allowing the enhance module 162 to transmit and receive an RF signal for each potential frequency to determine if the target material, or in this case the material related to the target material, has been detected. The enhance module 162 commands, at step 508, the transmitter unit 106 to configure the transmit signal. The transmitter unit 106 prepares the signal that will be transmitted for the purpose of detecting a target material. In some embodiments, the parameters and components may be set up with the desired characteristics to generate the RF signal. The control panel 146 determines the specific parameters of the RF signal that need to be generated. The parameters may include the frequency, amplitude, and modulation type required to effectively detect the target materials. Once the parameters are set, the control panel 146 sends a command to activate the oscillator circuit 108 within the transmitter unit 106. The oscillator circuit 108 may be responsible for generating a stable RF signal at the desired frequency and may consist of components like capacitors, inductors, and amplifiers that work together to create the oscillating signal. The power delivery to the oscillator circuit 108 may be managed by the SCR 114. When the control panel 146 sends a gate signal to the SCR 114, it switches from a non-conductive to a conductive state, allowing current from the power source, such as batteries, to flow to the oscillator circuit 108. After the oscillator circuit 108 generates the RF signal, the transformer 116 adjusts the voltage level of the signal to match the requirements of the transmit antenna 120. It may also provide impedance matching to ensure efficient signal transmission. The transformer 116 ensures that the RF signal is at the appropriate voltage and current levels for optimal transmission. For example, the control panel 146 may determine that an RF signal with a frequency of 50 Hz is required to detect a specific material. It sends a command to the transmitter unit 106 to configure this signal. The oscillator circuit 108 is activated, generating an RF signal at 50 Hz. The SCR 114 is triggered, allowing power from the batteries 122 to flow to the oscillator circuit 108. The generated signal is then conditioned by the transformer 116, ensuring it is at the correct voltage level for transmission The enhance module 162 commands, at step 510, the transmitter unit 106 to generate the transmit signal via the transmit antenna 120. The transmitter unit 106 generates the RF signal and transmits it through the transmit antenna 120 by converting electrical energy into radio waves that can be used for detecting specific materials. The transmit antenna 120 radiates the RF signal into the environment. The radio waves propagate through the medium, such as air or ground, and interact with the target materials. The interaction between the RF signal and the target materials will produce detectable changes in the signal, which can be received and analyzed by the receiver unit 124. For example, the transmitter unit 106 generates a wave pulse at a specified frequency that is transmitted directionally into the ground. The generated frequency is closely approximate or exact to that of the target material, and that relationship creates a responsive RF wave and/or a magnetic line between the transmitter antenna 120 and the target. When the RF detection device 102 is aligned with a target material, for example, when the opening of the directional shield 142 is pointing toward the target material, the voltage produced by the receiver antenna 126 changes and thereby produces a detection output signal, such as an audio signal having a tone different than that of the baseline. A reflective wave is produced by the target material that amplifies, resonates, offsets, or otherwise modifies the magnetic field passing through the receiver antenna 126 to alter the voltage produced, thereby generating the output signal. The receiver antenna 126 is responding to a voltage increase from the transmitter antenna 120 swinging over the magnetic line to the material. The enhance module 162 commands, at step 512, the receiver unit 124 to receive the RF signal. The receiver unit 124 captures the RF signal that has interacted with the environment and potential target materials using the receiver antenna 126. The receiver antenna 126 captures the incoming RF signal, which has been transmitted by the transmitter unit 106 and has interacted with the environment and any target materials present. The receiver antenna 126 may be designed to effectively capture these radio waves and convert them back into electrical signals. Once the RF signal is received by the receiver antenna 126, it may be fed into an RF amplifier, which boosts the signal strength without significantly altering its characteristics. In some embodiments, the use of the standard atomic structure of a material may be used to calculate the resonant frequency to which a particular substance would generate or respond. Each element and compound comprises a definable atomic structure composed of the total number of protons and neutrons of that target material. This unique nuclear composition of every substance makes it uniquely identifiable and detectable. The manner in which this information is applied thus enables the detection of any target substance. A target material can be detected and located based on a resonant, responsive RF wave and/or magnetic relationship between the target and a transmitter antenna 120 transmitting at a frequency specific and unique to the target material. The transmitter unit 106, through the transmitter antenna 120, induces a resonance due to responsive RF waves and/or magnetic and/or otherwise in a targeted material to resonate at a specific computed frequency. The receiver antenna 126 and receiver circuit 128 detect the resonance induced in the material and, in so doing, indicate the approximate line of bearing to the material. The primary method used by this detection system to detect specific materials is based on tuning the circuit 108 of the transmitter unit 106 to a specific value that is computed for the material of interest. The frequency can be based on any of the three defining characteristics of the substance, the number of protons, the number of neutrons, or the atomic mass, such as the sum of protons and neutrons and combinations thereof. The frequency can be transmitted at varying voltages to compensate for other external effects or interference. In some embodiments, a table or database of characteristics of common materials may be used to calculate the resonant frequencies. To accomplish this tuning, the frequency of the signal from the transmitter antenna 120 is set to some harmonic of the elements of the material. The enhance module 162 commands, at step 514, the receiver unit 124 to process the RF signal. The receiver unit 124 processes the received RF signal to extract meaningful data that can be analyzed for the presence of specific materials, which may involve further amplification, filtering, digitization, and initial data processing before the signal is sent to the control panel 146 for detailed analysis. In some embodiments, after the RF signal is received and initially amplified, it may require further amplification to ensure the signal is at an optimal level for processing. In some embodiments, an additional RF amplifier within the receiver unit 124 may boost the signal strength while maintaining its integrity. The amplified signal may be subjected to more advanced filtering by the filter circuit, which removes any residual noise and unwanted frequencies that might have passed through the initial filtering stage. In some embodiments, the filtering may involve bandpass filters that allow only the desired frequency range to pass through. The filtered analog signal may be converted into a digital format using an Analog-to-Digital Converter, ADC. The ADC samples the analog signal at a high rate and converts it into a series of digital values. The digitized signal may be processed using digital techniques. The digital signal may be fed into a Digital Signal Processor, DSP, within the receiver unit 124. In some embodiments, the DSP may perform initial data processing tasks such as demodulation, noise reduction, and feature extraction. Demodulation involves extracting the original information-bearing signal from the carrier wave. Noise reduction techniques may further clean the signal, making it easier to analyze. Feature extraction may involve identifying characteristics of the signal that are indicative of the presence of target materials. The enhance module 162 commands, at step 516, the receiver unit 124 to store the output in the probability database 168. The enhance module 162 may store the frequencies and power levels for the related material and each frequency and power level if the related material was detected or not. The enhance module 162 determines, at step 518, if there are more related materials stored in the probability database 168. The enhance module 162 may perform the detection process for each related material stored in the probability database 168, including sending multiple frequencies or using different power levels for each individual related material. If it is determined that there are more related materials stored in the probability database 168, the enhance module 162 extracts, at step 520, the next related material, and the process returns to comparing the related to the specific material database 166. If it is determined that there are no more related materials stored in the probability database 168, the enhance module 162 returns, at step 522, to the LLM module 160.

FIG. 6 is a flow chart of a method performed by the probability module 164. The process begins with the probability module 164 being initiated, at step 600, by the base module 156. The probability module 164 extracts, at step 602, the data from the probability database 168. The probability database 168 may include the target material, the associated frequencies and power levels of the target material if the target material was detected for each frequency and power level, the plurality of related materials, the associated frequencies and power levels for the related materials, if the related materials were detected for each frequency and power level, etc. The probability module 164 performs, at step 604, the probability algorithm. For example, the probability algorithm may use the extracted data from the probability database 168, such as the target material's name, its associated frequencies and power levels, detection status for each frequency and power level, related materials, their respective frequencies and power levels, and the detection status for each frequency and power level of the related materials. The probability algorithm may assign a base probability value to the detection of the target material, such as a default low probability, to ensure that further calculations can appropriately adjust it based on additional evidence. The probability algorithm then analyzes whether the target material was detected at its specific frequencies and power levels. The probability algorithm checks each frequency and power level combination recorded in the probability database 168 and notes the detection status. For example, the probability algorithm may check a Boolean or binary flag that indicates detection status, such as detected=true/false. Next, the probability algorithm may examine the detection status of related materials. The probability algorithm looks at the frequencies and power levels associated with each related material and determines if these related materials were detected, which may involve iterating through each related material and checking their detection records. The probability algorithm may adjust the initial probability of the target material being correctly identified based on the detection of related materials. Each detected related material positively influences the probability. The more related materials detected, the higher the confidence in the correct identification of the target material. The probability algorithm may aggregate the influences from all detected related materials and normalize the final probability score to ensure it is within a reasonable range, for example, 0 to 1 or 0% to 100%. The probability algorithm outputs the probability score, which represents the likelihood that the target material was correctly identified. In some embodiments, the score may be used for further decision-making or displayed to the user. For example, the probability algorithm may use a Rainforest probability function, which is a method that can handle multiple variables and their interactions to determine a probability score. If the probability algorithm is trying to determine the probability of the detection of uranium, the algorithm retrieves data for uranium, including its detection frequencies, such as 50 Hz, 100 Hz, etc., and power levels. The algorithm may also retrieve data for related materials like radon, thorium, and lead, including their detection frequencies and power levels. The initial probability for uranium detection may be set to a low value, such as 10%. The probability algorithm checks if uranium was detected at 50 Hz and 100 Hz across various power levels. For example, uranium may be detected at both frequencies and multiple power levels. The probability algorithm may check the detection status of radon, thorium, and lead at their respective frequencies and power levels. For example, radon and thorium may be detected, but lead is not. Each detected related material, such as radon and thorium, increases the probability score. For example, detecting radon might add 15% and thorium another 20%, resulting in a cumulative probability increase. The total contributions from related materials are summed and normalized. In some embodiments, if the cumulative score exceeds 100%, it may be scaled back to fit within the 0 to 100% range. The final probability score is output, indicating a high likelihood, such as 80%, that uranium is correctly identified based on the detection of uranium itself and the related materials, such as radon and thorium. The probability module 164 sends, at step 606, the output to the user interface 152. The probability module 164 may send the output of the probability algorithm to the user interface 152, such as 80% of uranium is correctly identified. In some embodiments, the probability module 164 may send the related materials that were detected to support the probability score. In some embodiments, the probability module 164 may send the related materials that were not detected to lower the probability score. In some embodiments, the probability module 164 may store the results of the probability algorithm for further analysis. In some embodiments, the probability module 164 may send the results of the probability algorithm to the 3rd party network 172 to further update the probability algorithm. The probability module 164 returns, at step 608, to the base module 156.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A method comprising:
receiving a selection of a target material from a user;
accessing a material database associating each of a plurality of materials with one or more corresponding resonance frequencies, the plurality of materials including the target material;
extracting a resonance frequency for the target material from the material database;
transmitting into an environment an RF signal at the resonance frequency for the target material;
receiving a response signal from the environment;
analyzing the response signal for resonance characteristics that indicate a presence of the target material in the environment; and
if the presence of the target material is indicated:
using a large language model (LLM) to determine a set of one or more related materials to the target material;
for each related material of the set of one or more related materials:
extracting the resonance frequency for the related material from the material database;
transmitting into the environment an additional RF signal at the resonance frequency for the related material;
receiving an additional response signal from the environment; and
analyzing the response signal for resonance characteristics that indicate a presence of the related material in the environment; and
storing an indication of the target material and each related material indicated to be within the environment.

2. The method of claim 1, further comprising:
using a probability algorithm to determine a probability of the target material being in the environment based, at least in part, on the presence of each related material indicated to be in the environment.

3. The method of claim 2, wherein using the probability algorithm includes:
assigning a base probability value to detection of the target material; and
adjusting the base probability value responsive to detection of the one or more related materials.

4. The method of claim 3, wherein adjusting the base probability value includes aggregating influences from all detected related materials and normalizing a final probability score to within a predetermined range.

5. The method of claim 2, wherein the probability algorithm includes a Rainforest probability function.

6. The method of claim 2, further comprising:
outputting to a user interface at least one of:
an indication of the target material;
an indication of the probability of the target material being in the environment; or
an indication of each related material indicated to be in the environment.

7. The method of claim 1, wherein the LLM is a pre-trained Bidirectional Encoder Representations from Transformers (BERT) model.

8. The method of claim 1, wherein the resonance frequency of the target material is related to an atomic structure of the target material.

9. The method of claim 1, wherein the material database associates each of the plurality of materials with one or more corresponding power levels, and wherein the RF signal is transmitted into the environment at a power level associated with the target material in the material database.

10. The method of claim 9, storing the indication of the target material and each related material indicated to be within the environment includes storing an indication of the target material and each related material indicated to be within the environment in a probability database along with one or more associated frequencies and/or power levels associated with the target material and/or related materials.

11. A system comprising:
a user interface configured to receive a selection of a target material from a user;
a communication interface for accessing a material database associating each of a plurality of materials with one or more corresponding resonance frequencies, the plurality of materials including the target material;
an RF transmitter configured to transmit into an environment an RF signal at the resonance frequency for the target material extracted from the material database;
an RF receiver configured to receive a response signal from the environment;
a processor configured to:
analyze the response signal for resonance characteristics that indicate a presence of the target material in the environment; and
if the presence of the target material is indicated:
use a large language model (LLM) to determine a set of one or more related materials to the target material;
for each related material of the set of one or more related materials:
transmit into the environment an additional RF signal at the resonance frequency for the related material extracted from the material database;
receive an additional response signal from the environment; and
analyze the response signal for resonance characteristics that indicate a presence of the related material in the environment; and
store an indication of the target material and each related material indicated to be within the environment.

12. The system of claim 11, wherein the processor is further configured to:
use a probability algorithm to determine a probability of the target material being in the environment based, at least in part, on the presence of each related material indicated to be in the environment.

13. The system of claim 12, wherein the processor is further configured to use the probability algorithm by:
assigning a base probability value to detection of the target material; and
adjusting the base probability value responsive to detection of the one or more related materials.

14. The system of claim 13, wherein the processor is further configured to adjust the base probability value by aggregating influences from all detected related materials and normalizing a final probability score to within a predetermined range.

15. The system of claim 12, wherein the probability algorithm includes a Rainforest probability function.

16. The system of claim 12, wherein the user interface is further configured to output at least one of:
an indication of the target material;
an indication of the probability of the target material being in the environment; or
an indication of each related material indicated to be in the environment.

17. The system of claim 11, wherein the LLM is a pre-trained Bidirectional Encoder Representations from Transformers (BERT) model.

18. The system of claim 11, wherein the resonance frequency of the target material is related to an atomic structure of the target material.

19. The system of claim 11, wherein the material database associates each of the plurality of materials with one or more corresponding power levels, and wherein the RF transmitter is configured to transmit the RF signal into the environment at a power level associated with the target material in the material database.

20. The system of claim 19, wherein the processor is further configured to store the indication of the target material and each related material indicated to be within the environment by storing an indication of the target material and each related material indicated to be within the environment in a probability database along with one or more associated frequencies and/or power levels associated with the target material and/or related materials.
